(19) United States
(12) Patent Application Publication
(10) Pub. No.: US 2009/0194488 A1
(43) Pub. Date: Aug. 6, 2009

(54) METHOD FOR TREATMENT OF CRYSTAL SLURRY

(75) Inventor: Noriaki Hosotani, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: IDEMITSU KOSAN CO., LTD, CHIYODA-KU (JP)

(21) Appl. No.: 12/300,028

(22) PCT Filed: May 9, 2007
(86) PCT No.: PCT/JP2007/059573

§ 371 Date: Nov. 7, 2008

(30) Foreign Application Priority Data
May 10, 2006 (JP) 2006-131274

(51) Int. Cl. B01D 33/60

(52) U.S. Cl. 210/772

(57) ABSTRACT

The present invention provides a method for the treatment of a crystal slurry by centrifugal washing, including a centrifugal separation step in which a slurry obtained by crystallizing a desired substance from a solution containing an organic component is subjected to solid liquid separation. The centrifugal separation step includes carrying out centrifugal separation to form a cake, and then washing the formed cake with an organic solvent so that the residual organic solvent content of the obtained crystals can be reduced to 1% by mass or less.

### TECHNICAL FIELD

The present invention relates to a method for the treatment of a crystal slurry by centrifugal washing, including a centrifugal separation step in which a slurry obtained by crystallizing a desired substance from a solution containing an organic component is subjected to solid liquid separation, the centrifugal separation step comprising carrying out centrifugal separation to form a cake, and then washing the formed cake with an organic solvent.

More specifically, the present invention is related to a method for the treatment of a crystal slurry by centrifugal washing, including a centrifugal separation step in which a slurry obtained by crystallizing a desired substance from a solution containing an organic component is solid-liquid separated into crystals and a mother liquor, wherein the mother liquor deposited onto and contained inside the crystals is efficiently washed off and separated using an organic solvent so that the residual organic solvent content of the obtained crystals can be reduced to 1% by mass or less.

### BACKGROUND ART

In a case where a desired substance contained in a liquid containing organic components is recovered by crystallizing the desired substance, a method is adopted which includes separating a slurry of the crystals into crystals and a mother liquor using a drum filter, a centrifugal separation machine, a horizontal belt filter or the like, and drying the obtained crystals in a drying step.

Patent Document 1 discloses a method for producing high purity adamantanes which comprises crystallizing adamantanes obtained by isomerizing trimethylenenorbornane by a crystallization method, subjecting the obtained crystallization liquid to solid-liquid separation by an ordinary method, such as vacuum filtration or centrifugation, using a filter cloth or a sintered metal, and then washing the obtained crude adamantanes with a washing solvent.

Patent Document 2 discloses a cleaning method using a filtration machine adapted to separate a crystal-containing liquid into a crystal component and a mother liquor with a filter medium, the cleaning method including filling a cleaning liquid in a rear face part of the filter medium to dissolve and recover crystals accumulating and adhering on the rear face of the filter medium.

However, no method for the treatment of a crystal slurry by centrifugal washing is known which includes a centrifugal separation step in which a mother liquor deposited onto and contained inside the crystals is efficiently washed off and separated using an organic solvent so that the residual organic solvent content of the obtained crystals can be reduced to 1% by mass or less and, therefore, substantially no drying step is needed.

[Patent Document 1] Japanese Unexamined Patent Application Publication No. 2004-59510

[Patent Document 2] Japanese Unexamined Patent Application Publication No. H07-47209

### DISCLOSURE OF THE INVENTION

### Problem to be Solved by the Invention

The present invention has been made to solve the problems under the above-mentioned circumstance and has as its object the provision of a method for the treatment of a crystal slurry, including a centrifugal separation step in which a slurry obtained by crystallizing a desired substance from a solution containing an organic component is subjected to solid liquid separation, the centrifugal separation step comprising carrying out centrifugal separation to form a cake, and then washing the formed cake with an organic solvent, so that the residual organic solvent content of the obtained crystals can be reduced to 1% by mass or less.

### Means for Solving the Problem

The present inventors have made an earnest study with a view toward accomplishing the above object and, as a result, have found that the above object can be accomplished by a method for the treatment of a crystal slurry by centrifugal washing, comprising a centrifugal separation step in which a slurry obtained by crystallizing a desired substance from a solution containing an organic component is subjected to solid liquid separation, said step comprising first carrying out centrifugal separation to form a cake, and then washing the formed cake with an organic solvent. The present invention has been completed based on this finding.

That is, the present invention provides:

(1) A method for the treatment of a crystal slurry by centrifugal washing, comprising a centrifugal separation step in which a slurry obtained by crystallizing a desired substance from a solution containing an organic component is subjected to solid liquid separation, said step comprising first carrying out centrifugal separation to form a cake, and then washing the formed cake with an organic solvent to obtain crystals having a residual organic solvent content of 1% by mass or less;
(2) The method for the treatment of a crystal slurry as defined in above (1), wherein said centrifugal washing is a two stage process comprising a first stage in which the slurry is centrifuged to form the cake, and a second stage in which the formed cake is washed with the organic solvent;
(3) The method for the treatment of a crystal slurry as defined in above (1) or (2), wherein the organic solvent used for washing is an organic compound having a boiling point of 100° C. or less;
(4) The method for the treatment of a crystal slurry as defined in any one of above (1) to (3), wherein the organic solvent is at least one organic solvent selected from the group consisting of methanol, ethanol, propanol, butanol, acetone, ethyl methyl ketone and petroleum hydrocarbon compounds having a boiling point of 55 to 100° C.;
(5) The method for the treatment of a crystal slurry as defined in any one of above (1) to (4), wherein the residual organic solvent content of the treated crystals is 0.05 to 1% by mass; and
(6) The method for the treatment of a crystal slurry as defined in any one of above (1) to (5), wherein the crystal slurry is an adamantane slurry.

### Effect of the Invention

According to the present invention, it is possible to provide a method for the treatment of a crystal slurry, which includes a centrifugal separation step in which a slurry obtained by crystallizing a desired substance from a solution containing an organic component is subjected to solid liquid separation, the centrifugal separation step comprising carrying out centrifugal separation to form a cake, and then washing the formed cake with an organic solvent so that the residual organic solvent content of the obtained crystals can be reduced to 1% by mass or less.

### BEST MODE FOR CARRYING OUT THE INVENTION

A method for the treatment of a crystal slurry by centrifugal washing according to the present invention is characterized in that, in its centrifugal separation step in which a slurry obtained by crystallizing a desired substance from a solution containing an organic component is subjected to solid liquid separation, a cake is first formed by centrifugation, and the formed cake is then washed with an organic solvent.

In the method for the treatment of a crystal slurry by centrifugal washing according to the present invention, the crystal obtained by crystallization is not specifically limited as long as it is an organic material crystal which has a hardness such that it is not crushed when subjected to a centrifugal force by a centrifugal separation device, which has a low porosity and which does not swell (or hardly swells) in organic solvents. A crystal of an adamantane may be mentioned as a preferred example of such a crystal. The particle size of the crystal is not specifically limited, either. Preferably, however, the crystal has an average particle diameter of 100 μm or more

A centrifugal washing device used for centrifugal washing of a crystal slurry in the present invention is not specifically limited as long as it has a structure permitting washing of a cake, obtained by centrifugal separation, with an organic solvent. Such a centrifugal washing device is not specifically limited as long as it has functions to first solid-liquid separate a slurry, obtained by crystallization, by centrifugal separation, to then spray an organic solvent over the fluid crystal cake, to wash off a mother liquor which deposits to surfaces of the crystals and a mother liquor and impurities which are included in aggregates of the crystals, to remove the solvent, and to discharge the crystal cake. A centrifugal washing device of a two stage type adapted for centrifuging the slurry to form a cake in the first stage and for washing the formed cake with an organic solvent in the second stage is also preferably used. Also preferably used is a horizontal type continuous centrifugal separation device which permits a continuous treatment and requires only a small installation space, which is high in solid-liquid separation efficiency and is excellent in treatment capacity and which has an inlet port for feeding an organic solvent for use in washing. Among them, a decanter of a rotary type provided inside with a screw conveyor or a decanter of a type which is composed of two unit structures (second unit is used for washing) each having a diameter reduced toward its crystal cake discharging side. As a preferred decanter, there may be mentioned a commercially available Model CR decanter manufactured by Tanabe Willtec Inc.

The organic solvent used for washing is preferably an organic compound having a boiling point of 100° C. or less. Particularly preferred is an organic compound having a boiling point of about 30 to 100° C. More particularly, there may be mentioned at least one organic compound selected from the group consisting of methanol, ethanol, propanol, butanol, acetone, ethyl methyl ketone and petroleum hydrocarbon compounds having a boiling point of 55 to 100° C. such as IPSOL-L (IP-L) (trade name, manufactured by Idemitsu Kosan Co., Ltd.).

The amount of the organic solvent used for washing is not specifically limited, but the organic solvent is generally used in an amount of about 0.5 to 10 liters per 1 kg of the crystal cake fed to the centrifugal washing device.

After the washing, the crystal cake is discharged with a high centrifugal force and at a high speed owing to the centrifugal separation machine. Therefore, the crystal cake is dispersed due to gas resistance to cause a great increase of the surface area. As a consequence, drying occurs instantaneously so that the residual content of the organic solvent in the crystal cake is reduced to 1% by mass or less, particularly about 0.05 to 1% by mass. Therefore, the crystals can be obtained in such a drainage state that substantially no further drying by a drying step is needed.

The residual content of the organic solvent in the crystal cake is measured as follows:

(W1−W2)/W1×100

where W1 represents a mass (g) of the crystal cake just discharged from the centrifugal separation machine, and W2 represents a mass (g) of the crystal cake after the just discharged crystal cake has been dried at a temperature of 40° C. and a pressure of 10 kPa (absolute pressure) for 24 hours.

A portion of the separated mother liquor is generally discharged outside the system in order to prevent concentration of the impurities, with all or part of the remainder portion thereof being, if desired, recycled to the crystallization step.

### EXAMPLE

The present invention will be next described in more detail with adamantane as example. It should be noted, however, that the scope of the present invention is not limited to these examples in any way.

### Example 1

(1) Catalyst Preparation Step:

In 2,000 kg of pure water were suspended, with stirring, 235 kg of sodium ion-exchanged Y-type zeolite (hereinafter referred to as NaY), to which a dilute aqueous nitric acid solution was added to adjust the pH of the suspended slurry to 5.5.

Then, a solution of 246 kg of lanthanum nitrate hexahydrate dissolved in 500 kg of warm water was gradually mixed into the above suspended slurry. The mixture was then heated to 90° C. and stirred for30 minutes, followed by filtration and washing. The washed cake was then dried overnight at 110° C. and calcined at 600° C. for 3 hours.

The obtained calcined powder was mixed again into 2,000 kg of pure water with stirring. The obtained suspended slurry was added with 228 kg of ammonium sulfate and stirred at 95° C. for 30 minutes, followed by filtration and washing. The washed cake was again suspended in 2,000 kg of pure water and subjected to the similar ion exchanging treatment twice successively.

Thereafter, the formed cake was dried overnight at 110° C. This was placed in a tubular vessel and steamed at 510° C. for 30 minutes with 100% steam. The obtained powder was then suspended in 2,000 kg of pure water, to which 32 kg of 25% by mass sulfuric acid were slowly added. Thereafter, the mixture was heated at 95° C. for 30 minutes.

Subsequently, the mixture was filtered, washed and again suspended in 2,000 kg of pure water. The obtained suspension was added with 180 kg of a 1.71% by mass aqueous platinum tetramine chloride solution. The mixture was heated at 60° C. for 30 minutes, filtered, washed, dried overnight at 110° C., thereby obtaining La-containing Y-type zeolite supporting 0.87% by mass of platinum by ion exchange.

(2) Reaction Step:

A stainless steel reaction tube having a total length of 3.5 m and a diameter of 24 cm was filled with 100 kg of the catalyst obtained in (1) above.

After the atmosphere had been substituted with nitrogen, hydrogen reduction was carried out at 300° C. under ambient pressure for 2 hours in a hydrogen stream. Then, feed of trimethylene norbornane (TMN) (at a rate of 20 kg/hr), decalin as a dilution solvent (at a rate of 30 kg/hr) and hydrogen (at a rate providing a hydrogen/TMN molar ratio of 2.5) was started to continuously perform isomerization at 300° C. under 5 MPa.

The reaction liquid was concentrated by atmospheric distillation (with 15 plates) at a tower bottom temperature of 180° C. until an adamantane concentration of 30% by mass was reached.

(3) Refining Step:

The concentrate obtained in (2) above was used as a crystallization feedstock. Thus, 100 kg of the concentrate was charged in a dissolution and crystallization vessel and stirred at 120° C. for dissolution. With continued stirring, the solution was cooled to 10° C. to crystallize adamantane and to obtain a slurry of precipitated adamantane. The slurry was then fed to a horizontal-type centrifugal washing device at a feed rate of 244 kg/hr. Thereafter, IPSOL-L (IP-L, trade name, manufactured by Idemitsu Kosan Co., Ltd.) as an organic washing solvent was fed at a rate of 54 kg/hr to perform solid-liquid separation and washing. The obtained crystals had a residual solvent content of 0.1% by mass and were powdery crystals which did not substantially require to be dried.

### Comparative Example 1

Solid-liquid separation and washing were performed in the same manner as that in Example 1 except that toluene was used as the organic washing solvent. The obtained crystals had a residual solvent content of 5% by mass. It was necessary to dry the crystals in a drying step.

### Comparative Example 2

Solid-liquid separation was performed in the same manner as that in Example 1 except that a horizontal belt filter was used. The obtained crystals had a residual solvent content of 5 to 10% by mass. It was necessary to dry the crystals in a drying step.

### INDUSTRIAL APPLICABILITY

The present invention provides a method for the treatment of a crystal slurry, including a centrifugal separation step in which a slurry obtained by crystallizing a desired substance from a solution containing an organic component is subjected to solid liquid separation, the centrifugal separation step including carrying out centrifugal separation to form a cake, and then washing the formed cake with an organic solvent so that the residual organic solvent content of the obtained crystals can be reduced to 1% by mass or less.

1. A method for the treatment of a crystal slurry by centrifugal washing, comprising a centrifugal separation step in which a slurry obtained by crystallizing a desired substance from a solution containing an organic component is subjected to solid liquid separation, said step comprising first carrying out centrifugal separation to form a cake, and then washing the formed cake with an organic solvent to obtain crystals having a residual organic solvent content of 1% by mass or less.

2. The method for the treatment of a crystal slurry according to claim 1, wherein said centrifugal washing is a two stage process comprising a first stage in which the slurry is centrifuged to form the cake, and a second stage in which the formed cake is washed with the organic solvent.

3. The method for the treatment of a crystal slurry according to claim 1, wherein the organic solvent used for washing is an organic compound having a boiling point of 100° C. or less.

4. The method for the treatment of a crystal slurry according to claim 1, wherein the organic solvent is at least one organic solvent selected from the group consisting of methanol, ethanol, propanol, butanol, acetone, ethyl methyl ketone and petroleum hydrocarbon compounds having a boiling point of 55 to 100° C.

5. The method for the treatment of a crystal slurry according to claim 1, wherein the residual organic solvent content of the treated crystals is 0.05 to 1% by mass.

6. The method for the treatment of a crystal slurry according to claim 1, wherein the crystal slurry is an adamantane slurry.
